(19) United States
(12) Patent Application Publication
(10) Pub. No.: US 2003/0030383 A1
(43) Pub. Date: Feb. 13, 2003

(54) Process for the manufacture of an electroluminescent film and application of such a film

(76) Inventor: Rafael Revivo, Jerusalem (IL)

Correspondence Address: SCHNADER HARRISON SEGAL & LEWIS, LLP, 1600 MARKET STREET, SUITE 3600, PHILADELPHIA, PA, 19103

(21) Appl. No.: 10/068,620

(22) Filed: Feb. 5, 2002

(30) Foreign Application Priority Data
Feb. 5, 2001 (FR) FR 01/01512

(51) Int. Cl. G09G 3/10

(52) U.S. Cl. 315/169.3

(57) ABSTRACT

The present invention pertains to a process for the manufacture of an electroluminescent film, characterized in that one deposits on a pliable, transparent, nonconductive substrate a cord made of a resistive material surrounding at least one zone, and in that one then proceeds to deposit at least seven layers of an electroluminescent material by alternating steps of coating and drying, and that the complex prepared in this manner is then covered by a pliable film.

The present invention pertains to the field of photoluminescent materials and their applications.

Known in the state of the art is PCT patent WO 97/48254 which describes a device that uses electrodes (10) presented in the form of electroconductive, translucent and pliable plastic films for the manufacture of electroluminescent lamps, electronic display signs and other similar display devices. In order to manufacture these electrodes, layers of conductive oxide are formed on the surfaces of a perforated plastic film or a plastic cloth. The layers of conductive oxide, e.g., indium stannic oxide, communicate via the perforations or weave spaces so as to establish an integral electric communication between the opposite surfaces of the electrode. Another process involves forming an electrode containing a conductive strip from translucent plastic strips that are coated in advance with the conductive oxide.

Patent WO 89/12376 describes a pliable electroluminescent lamp assembly comprising a multiplicity of thin layers each comprising a pliable plastic substrate and at least one electroconductive layer. There is positioned between two other thin layers a first thin light-emitting layer which comprises an electroluminescent layer and a light-transmitting conductor (24). The second and third thin layers provide, respectively, a bus bar and the rear electrodes.

Such devices require the use of an electrically conductive substrate. It is difficult to find support films that exhibit both good optical performance (transparency, lack of coloration) and good electrical conductivity.

Patent WO 00/72637 pertains to an electroluminescent color display comprising a substrate on which are formed successively a fluorescent conversion layer and/or a fluorescent material containing a color filter, an organic layer, a barrier layer and an organic electroluminescent structure. The organic layer is constituted by an ultraviolet-curable, thermosetting resin with the barrier layer containing silicon.

Japanese patent application JP 10119599 pertains to an electroluminescent element presenting a ceramic product in layers comprising a substrate, a first layer with electrode effect and a first layer with insulating effect, and comprising in at least one of the insulating layers a dielectric material of a specified composition constituted principally in molar percentage of from 0.1 to 3% MgO, from 0.05 to 1.0% MnO, up to 1% of Y₂O₃, from 2 to 12% of BaO+CaO and from 2 to 12% of SiO₂, for a molar percentage of 100% of BaTiO₃.

These various solutions require high-voltage power which is not really suitable for applications involving security or displays. Furthermore, they do not enable production of regular, homogeneous luminescence.

The object of the present invention is to resolve the disadvantages of the devices of the prior art by proposing a pliable element that consumes low amounts of electricity and produces homogeneous, constant lighting. Another objective of the invention is to attain long life spans and small thicknesses on the order of 0.5 mm.

The invention pertains first of all to a process for the manufacture of an electroluminescent film characterized in that one deposits on a pliable transparent substrate a cord made of a resistive material surrounding at least one zone, and in that one then proceeds to deposit at least seven layers of an electroluminescent material by alternating steps of coating and drying, and that the complex prepared in this manner is then covered by a pliable film. The substrate and the dorsal film are constituted by an insulating plastic material.

The number of layers of electroluminescent material is preferably comprised between 9 and 14.

According to a preferred mode of implementation, an opaque or semi-opaque pliable material is deposited between the electroluminescent zones.

The invention pertains especially to an electroluminescent element characterized in that it is constituted by a transparent plastic film on which is deposited at least one cord made of a resistive material delimiting a zone on which is deposited at least seven layers of electroluminescent material, with the entire assembly being coated with a pliable film forming the rear surface, with the conductive cord(s) being provided with an electrical connection means. The resistive material is, for example, constituted by a resin charged with aluminum powder.

The two pliable films are advantageously heat-sealed on their carrier.

The invention also pertains to a system comprising an element in accordance with the invention and moreover a power source delivering an alternating current on the order of 450 Hz.

The system advantageously comprises a multiplicity of conductive cords each of which delimits a closed zone, with the surface comprised between said zones being opaque, and the system furthermore comprising a high-frequency electrical power source.

According to a first application, the invention pertains to a security system constituted by at least one element according to the invention, and comprising a multiplicity of conductive cords, each of which delimits a closed zone, with the system furthermore comprising an electrical power source formed by a box containing at least one battery, and a high-frequency AC/DC converter whose output is connected to the two ends of each of the conductive cords.

According to a second application, the invention pertains to a lighting system constituted by at least one element according to the invention, and comprising a multiplicity of conductive cords, each of which delimits a closed zone, with the system furthermore comprising an electrical power source formed by a box containing at least one battery, and a high-frequency AC/DC converter whose output is connected to the two ends of each of the conductive cords.

According to a third variant, the invention pertains to an article of clothing characterized in that it comprises at least one element according to the invention, and comprising a multiplicity of conductive cords, each of which delimits a closed zone, with the system furthermore comprising an electrical power source formed by a box containing at least one battery, and a high-frequency AC/DC converter whose output is connected to the two ends of each of the conductive cords.

Better comprehension of the invention will be obtained from the description below which refers to the attached drawings in which:

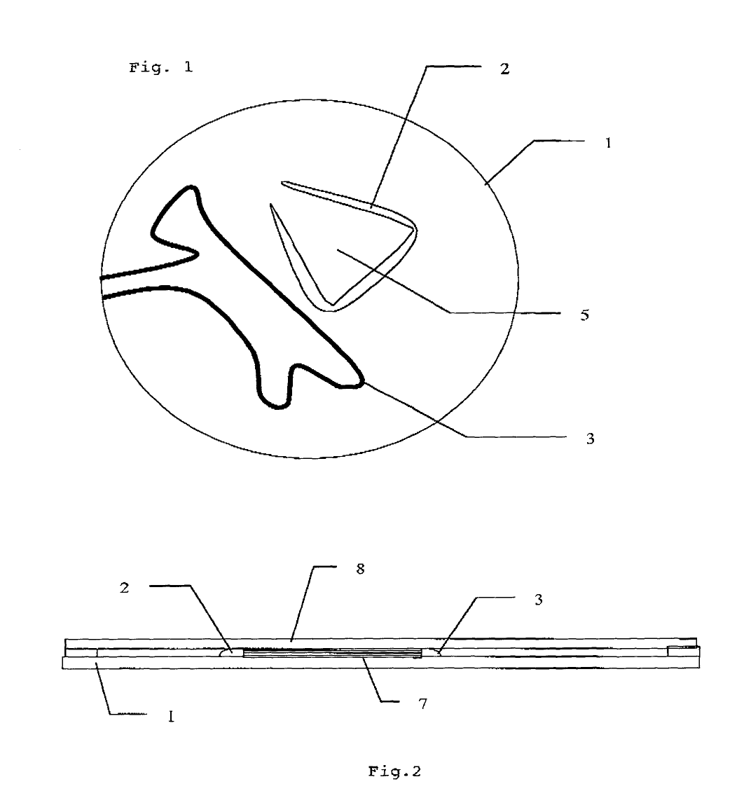

FIG. 1 shows a top view of an element according to the invention,

FIG. 2 shows a sectional view of such an element.

The element is constituted by a pliable or flexible substrate (1), e.g., a polypropylene film. On this substrate (1) is deposited a conductive cord (2, 3) delimiting a zone (4, 5) on which are deposited nine layers of an electroluminescent material.

The conductive cord can be made of a metallic conductive film, a metallic ink or a matrix charged with metallic powders.

In the zones delimited by each cord, a first layer (7) of electroluminescent material is deposited by coating, then drying is performed, then the operation is repeated by depositing on the dried layer a new layer of electroluminescent material which is dried, and these steps are continued until the last layer.

A colored pigmented layer can be deposited between the cords.

The entire assembly prepared in this manner is then covered by a pliable or flexible film (8) sealed by heat sealing with the first film (1). Film (8) is opaque and forms the rear surface.

The entire assembly is the object of a lamination operation when the two exterior films are assembled. The entire assembly has a thickness on the order of 0.2 to 0.6 mm.

The conductive cords are connected at both of their ends to a low-voltage, e.g., 3 volts, source of alternating current at 450 Hz (or more broadly between 50 and 2000 Hz). The electrical power required is on the order of 10 mW per cm².

Such elements have varied applications:

advertising signs

decorative elements

lighting sources, especially for the rear projection of liquid crystal screens,

safety clothing such as a belt or vest.

1. Process for the manufacture of an electroluminescent film, characterized in that one deposits on a pliable, transparent, nonconductive substrate a cord made of a resistive material surrounding at least one zone, and in that one then proceeds to deposit at least seven layers of an electroluminescent material by alternating steps of coating and drying, and that the complex prepared in this manner is then covered by a pliable film.

2. Process for the manufacture of an electroluminescent film according to claim 1, characterized in that the number of layers of electroluminescent material is comprised between 9 and 14.

3. Process for the manufacture of an electroluminescent film according to claim 1 or 2, characterized in that an opaque or semi-opaque, pliable material is deposited between the electroluminescent zones.

4. Electroluminescent element characterized in that it is constituted by a transparent plastic film on which is deposited at least one cord made of a resistive material delimiting a zone on which is deposited at least seven layers of electroluminescent material, with the entire assembly being coated with a pliable film forming the rear surface, with the conductive cord(s) being provided with an electrical connection means.

5. Electroluminescent element according to claim 4, characterized in that the two pliable films are heat sealed on their carrier.

6. System comprising an element according to claim 4 or 5, characterized in that it moreover comprises a power source delivering an alternating current on the order of 450 Hz.

7. Decorative or advertising system characterized in that it is constituted by an element accord to claim 4 or 5, comprising a multiplicity of conductive cords each of which delimits a closed zone, with the surface comprised between said zones being opaque, and the system furthermore comprising a high-frequency electrical power source.

8. Security system characterized in that it is constituted by at least one element according to claim 4 or 5, comprising a multiplicity of conductive cords, each of which delimits a closed zone, with the system furthermore comprising an electrical power source formed by a box containing at least one battery, and a high-frequency AC/DC converter whose output is connected to the two ends of each of the conductive cords.

9. Lighting system characterized in that it is constituted by at least one element according to claim 4 or 5, comprising a multiplicity of conductive cords, each of which delimits a closed zone, with the system furthermore comprising an electrical power source formed by a box containing at least one battery, and a high-frequency AC/DC converter whose output is connected to the two ends of each of the conductive cords.

10. Article of clothing characterized in that it comprises at least one element according to claim 4 or 5, comprising a multiplicity of conductive cords, each of which delimits a closed zone, with the system furthermore comprising an electrical power source formed by a box containing at least one battery, and a high-frequency AC/DC converter whose output is connected to the two ends of each of the conductive cords.
